(19) United States
(12) Patent Application Publication
(10) Pub. No.: US 2005/0138229 A1
(43) Pub. Date: Jun. 23, 2005

(54) Method and apparatus for remote operation of a USB peripheral

(76) Inventor: Ronald H. Sartore, Poway, CA (US)

Correspondence Address: MARGER JOHNSON & McCOLLOM, P.C., 1030 S.W. Morrison Street, Portland, OR, 97205, US

(21) Appl. No.: 10/746,774

(22) Filed: Dec. 23, 2003

(51) Int. Cl. G06F 3/00

(52) U.S. Cl. 710/15

(57) ABSTRACT

Embodiments of the invention replace a USB cable between a USB host and a USB peripheral for remote operation of the USB peripheral while simultaneously maintaining software and operational compatibility. Alternative embodiments of the invention may use RF, IR, fiber-optic, or telephone links, or any other acceptable link. Some embodiments of the invention support wireless Hi-Speed USB.

### BACKGROUND OF THE INVENTION

1. Technical Field of the Invention

This disclosure relates to data communication over a bus, and, more particularly, to a method and apparatus for extending the operating distance between a host and a peripheral beyond typical bus distance limitations, while still maintaining software and operational compatibility between the host and peripheral.

2. Description of the Related Art

In the past, computers included multiple communication ports to facilitate data communication, such as a serial port, parallel port, keyboard port, mouse port, etc. In response to the proliferation of numbers of different ports, each having a different electrical design and characteristics, a standard “universal” bus was proposed and has been implemented with great success. This Universal Serial Bus (USB) standard includes a standard peripheral interface, reduces the need for multiple connectors and cables, and allows peripheral devices to be connected to a host even when the host is powered.

The USB standards support various data transfer rates. USB 1.x standards support data transfer rates of 1.5 Mb/s (Low speed) and 12 Mb/s (Full speed). USB 2.x standards support 480 Mb/s (High speed) data transfer rates, in addition to supporting the Full speed and Low speed rates. Thus, USB 2.x is backwards compatible with USB 1.x.

As used in this disclosure, “USB” refers to any or all of the individual standards, unless particular standards are specifically excluded. A single USB port can be used to connect up to 127 peripheral devices, such as mice, modems, and keyboards. USB also supports Plug-and-Play installation.

An example connection made by USB is illustrated in FIG. 1, where a host 5, such as a computer, is coupled by a USB cable 10 to a peripheral device 20, such as a digital camera. The host includes a USB interface 12 that is connected to a processor 14, and, by extension, to memory 16. Data transferred to or received from the peripheral device 20 can be stored in the memory 16 for use by programs or the operating system operating on the processor 14. Similarly, the peripheral 20 includes a USB interface 22, which is connected to the host USB cable 10. The USB interface 22 and USB cable 10 carry data and instructions between the host 5 and the peripheral 20.

Since USB is a wired standard, it has stringent electrical constraints that restrict its distance. This is particularly true for Hi-Speed USB. However, oftentimes it would be beneficial to “extend” the length of a USB link, i.e., to have a greater distance between a host and a peripheral device than is currently allowed in the USB specifications.

One option to extend a USB link includes inserting a wireless link between the host and peripheral, e.g., inserting an IR or RF link. The wireless link could operate at distances greater than can typical USB standards, which in effect extends the overall operating distance between the host and USB peripheral.

There have been several attempts to extend USB with wireless links, but these approaches have several disadvantages. First, directly replicating the present 1/0 state transitions of USB with a radio link requires a quality of service that is unrealistic. Additionally, current 1/0 state replication schemes do not architecturally scale in performance and cannot support speeds beyond the USB 1.1 (12 Mb/s) standard.

Another proposal is to use a separate protocol (such as Bluetooth) that is on top of or displaces the USB protocol. This has the disadvantage that it is not transparent to the user, requires software upgrades and/or changes, and may not work on older systems. Such separate protocols would require an intermediary signaling scheme, or in other words, the translation of USB signals. These approaches cannot achieve the performance necessary for Hi-Speed USB.

Thus, presently there is no practical and scalable way to extend the distance between a host and USB peripheral. Embodiments of the invention address these and other disadvantages of the prior art.

### BRIEF DESCRIPTION OF THE DRAWINGS

Some embodiments of the invention will be described with reference to the following drawings, in which like reference numbers refer to like elements.

FIG. 1 is a block diagram that illustrates a USB host device and peripheral device according to the prior art.

FIG. 2 is a block diagram that illustrates an apparatus and method for remote operation of a USB peripheral according to embodiments of the invention.

FIG. 3 is a functional block diagram that illustrates operation of a peripheral emulator according to embodiments of the invention.

FIG. 4 is a block diagram that illustrates an apparatus and method for wireless remote operation of a USB peripheral according to some embodiments of the invention.

FIG. 5 is a block diagram that illustrates an alternate communication channel between a peripheral emulator and a host emulator according to some embodiments of the invention.

FIG. 6 is a flow diagram illustrating some of the processes performed by the embodiments of the invention shown in FIGS. 2-5.

FIG. 7 is a flow diagram showing detailed processes that can be performed within the flow diagram of FIG. 6.

### DETAILED DESCRIPTION OF THE INVENTION

Embodiments of the invention allow a USB peripheral to communicate to a USB host even though the host and peripheral are not connected by a typical USB cable. Specifically, a host is connected to and communicates with an “emulated peripheral”, or device that is configured to appear to the host that it is the connected peripheral. The actual peripheral is, likewise, connected to an emulated host. Between the emulated peripheral and the emulated host is a communication link, which is most likely something other than USB, and typically would have greater distance properties than USB. When the actual host sends signals to the emulated peripheral, the signals are received by the emulated peripheral, converted to the signal requirements of the communication link, and sent to the emulated host. The emulated host then converts the signals back to USB, and sends them to the actual peripheral as USB signals. The peripheral communicates signals back to the host in a similar manner.

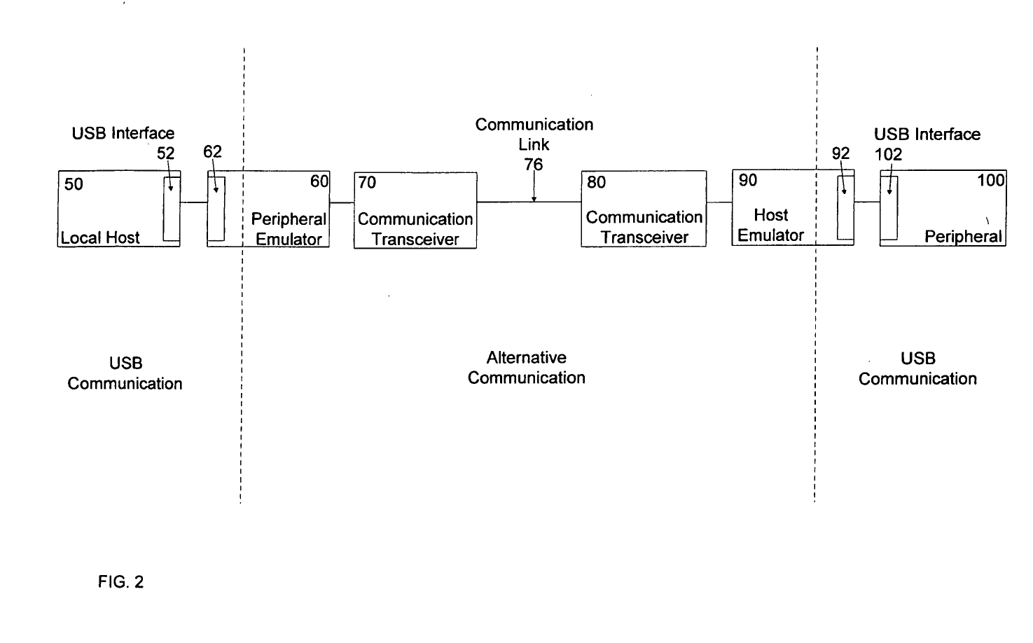

FIG. 2 is a block diagram that illustrates an apparatus and method for remote operation of a USB peripheral with a local host according to embodiments of the invention. The system of FIG. 2 includes a local host 50 and a peripheral device 100. The host 50 and peripheral 100 each include a USB interface 52, 102, respectively. In many, if not all, embodiments, the peripheral 100 could plug directly into the host 50 using a USB cable (not shown). The peripheral 100 may be any conventional USB peripheral such as a keyboard, a mouse, printer, digital camera, or a storage device. In addition, the peripheral 100 may be a USB hub that has several peripherals connected to it. Likewise, the local host 50 may be any conventional device that is typically directly connected to a peripheral 100 with a conventional USB cable, such as a personal computer, or PC.

The local host 50 is coupled to a peripheral emulator 60, which may be similar to a configurable USB peripheral device such as described in U.S. Pat. No. 6,012,103, which is hereby incorporated by reference, and progeny. The peripheral emulator 60 is described below in detail. The peripheral emulator 60 also includes an interface 62, which may be a USB interface.

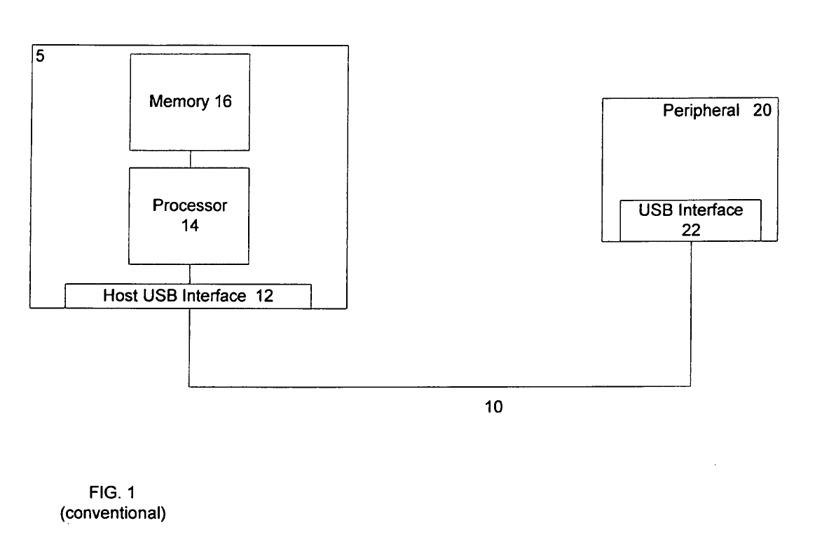

The peripheral emulator 60 is coupled to a first communication transceiver 70, which in turn is coupled by way of a communication link 76 to a second communication transceiver 80. The types and components of the transceivers 70, 80 are dictated by the type of communication link 76 used in the system illustrated in FIG. 1. Some example communication links 76 include fiber optic cable, telephone lines, computer (e.g., Ethernet) cable, and wireless solutions, such as RF or IR signals. The communication link 76 is typically longer than any distance allowed by USB 1.0, 1.1, or 2.0, but this is not necessary.

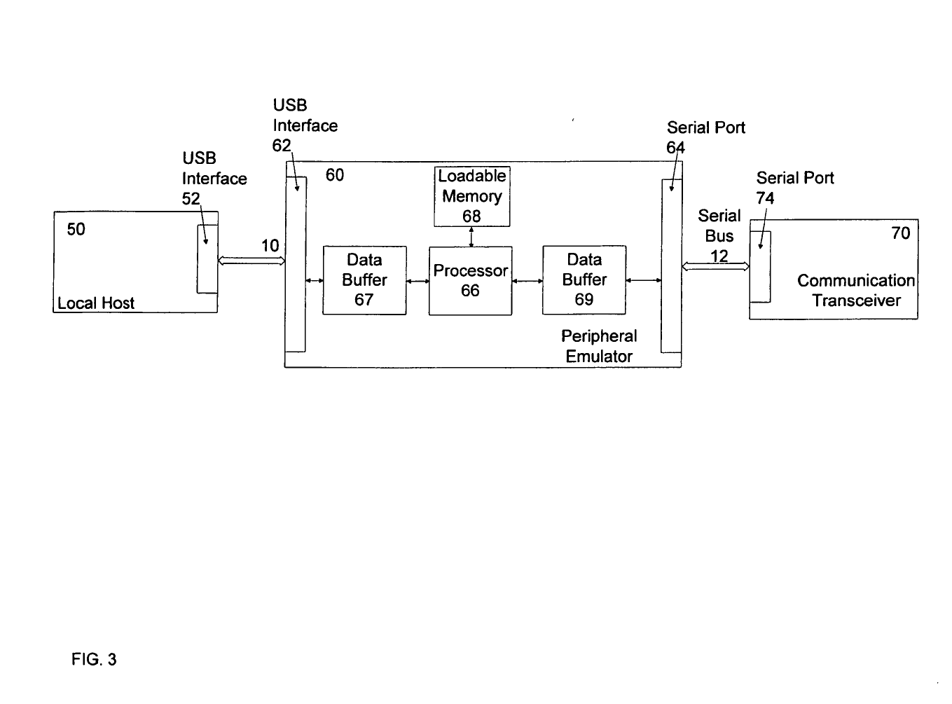

After the type of communication link 76 is determined, the particular transceivers 70, 80 are selected that can effectuate communication over the communication link. For example, if the communication link 76 is a telephone line, transceivers 70 and 80 can be implemented using MODEMs (MODulators-DEModulators). Similarly, if the communication link 76 is a fiber optic cable, the transceivers 70 and 80 can be electro/optical communicators. Examples where the communication link 76 is a wireless link are described below with reference to FIG. 3.

Still referring to FIG. 2, the second communication transceiver 80 is coupled to a host emulator 90, which in turn is coupled to the peripheral 100 through the USB interface 102. Similar to the peripheral emulator 60, the host emulator 90 includes an interface 92, which may be a USB interface.

Therefore, within the system illustrated in FIG. 2, there are two separate, but related, communication systems. The first communication system is USB, which is ultimately communicated between the local host 50 and the peripheral 100. The second communication system is interposed within the USB system, and is used between the first and second transceivers 70 and 80. In FIG. 2, this communication system is termed “alternative” communication, which means that it could be an alternative to USB communication. Generally, the alternative communication would provide a benefit that cannot be met by USB, such as a long distance requirement, or the ability to communicate wirelessly.

Because there are two different communication systems illustrated in FIG. 2, information from the first system (USB) must be provided to or translated to the second communication system (non-USB, most likely) to enable the transceiver 70 to send the data to the transceiver 80. Likewise, the information received by the transceiver 80 must be again translated or put into USB to be provided to the peripheral device 100. In FIG. 2, this switching or transferring data between communication systems is represented as crossing the dotted lines. For instance, the local host 50 sends data, using USB, to the peripheral emulator 60. Before the data is sent to the first communication transceiver 70, the data must be provided to or translated in a format that can be sent over the alternative communication system. Because, to embodiments of the invention, it does not matter which communication system is used between the transceivers 70 and 80, so long as communication can ultimately occur between the local host 50 and the peripheral device 100, it likewise does not matter how data is transferred between the USB communication system and the alternative communication system.

As illustrated in FIG. 2, the delivery of data from the USB system to the system chosen between the transceivers 70 and 80 occurs in the peripheral emulator 60. Additionally, the host emumlator 90 translates data from the chosen system back to USB, to be provided to the peripheral 100. Of course, FIG. 2 is only a functional diagram, and does not necessarily mean that a particular piece of hardware, or software process, must be located within the emulators 60 and 90 to translate data between the communication systems. The data translation could also occur in the transceivers 70, 80.

As is known in the art, there are several ways to provide data from one communication system to another. As described above, providing the data from USB to the alternate communication method (and back) may occur in the emulators 60, 90. Designing and implementing such communication systems is well within the ability of one skilled in the art. For example, the emulators 60, 90 may include conventional serial or parallel busses or interfaces to send data from the USB “side” to the alternate “side.” Further, these interfaces could simply be line traces within a single chip (one for each emulator 60, 90). Additionally, instead of passing data signals themselves, memory addresses or pointers could be passed, indicating a memory location of the stored data to be used by the alternate communication system. Pre-designed systems also exist, such as using a Universal Asynchronous Receiver/Transmitter (UART) within the emulators 60, 90, and transceivers 70, 80.

The system described with reference to FIG. 2 includes two emulated components, specifically the peripheral emulator 60 and the host emulator 90, which are configured to allow the system to operate in the best manner possible. In particular, the peripheral emulator 60 is set to match the parameters of peripheral 100 such that the local host 50, when it is communicating with the peripheral emulator 60, believes it to be communicating with the peripheral 100 itself.

So that the peripheral emulator 60 can emulate the peripheral 100, parameters and settings from the peripheral 100 must be communicated to the peripheral emulator 60, and the emulator 60 set according to those parameters and settings.

Before the peripheral emulator 60 can be set to emulate the peripheral 100, several intermediate processes may be performed. Initially, when the peripheral 100 is first plugged in, powered, or otherwise connected to the host emulator 90, the host emulator 90 enumerates or interrogates the peripheral 100. During this process, the peripheral 100 provides certain configuration information to the host emulator 90.

The configuration information may include the number, direction, and type of USB endpoints that the peripheral 100 possesses. According to USB 2.0, a peripheral may have up to 31 USB endpoints. The direction of the endpoints is either In or Out, and there are four types of endpoints—Control, Interrupt, Isochronous, and Bulk. Future USB specification revisions may support larger numbers and types of endpoints for the peripheral 100, and alternative embodiments of the invention are intended to encompass these modifications as well. During the enumeration/interrogation, the peripheral 100 provides all of the information for all of its endpoints to the host emulator 90.

The peripheral 100 also provides other USB information to the host emulator 90 such as the Vendor ID, the Product ID, and the Device ID. These numbers specify the manufacturer of the peripheral 100, the type of peripheral 100, and the individual peripheral 100. In alternative embodiments of the invention, more parameters than those mentioned above may be supplied to the host emulator 90 by the peripheral 100.

With reference to FIG. 2, following the enumeration/interrogation phase described above, the host emulator 90 transmits the gathered USB information to the second communication transceiver 80, which in turn formats, packages, and transmits the information to the first communication transceiver 70 over the communication link 76. The first communication transceiver 70 then passes the configuration information to the peripheral emulator 60. There are alternative methods to provide this information to the peripheral emulator 60, which are described below.

After the peripheral emulator 60 receives the enumeration/interrogation data about the peripheral 100, next the peripheral emulator 60 uses the configuration information to configure itself so that it appears to the local host 50 as the peripheral 100. That is, the peripheral emulator 60 conveys to the local host 50 all the USB related information (number, type, and direction of the USB endpoints along with Vendor, Product, and Device ID) that identifies it to the local host 50 as if the peripheral 100 were directly connected to the local host 50.

After the local host 50 has received the USB related information from the peripheral emulator 60, communications between the local host 50 and the peripheral 100 may begin using the communication link 76. Specifically, USB signals are sent from the local host 50 to the peripheral emulator 60. The USB signals are converted, translated, or otherwise provided to the first communication transceiver 70, which sends data along the communication link 76 to the second communication transceiver 80. After receiving the transmitted data, the second communication transceiver 80 converts, translates, or otherwise provides the data to the host emulator 90. The host emulator 90 then sends USB signals to the peripheral 100. Thus, in some embodiments, the exact USB signals that were sent by the local host 50 to the peripheral emulator 60 are sent by the host emulator 90 to the peripheral 100.

There may be some latency that occurs as the information is relayed from the local host 50 to the peripheral 100 and vice versa, but, using embodiments of the invention, overall, the functional compatibility is maintained between the local host 50 and the peripheral 100. Latency effects may be lessened by using techniques known in the art, such as by using data buffers, or by using specialized commands, such as look-ahead reads or pre-fetches. Other techniques for lessening impacts of two communication systems having different speeds as known to those in the art may also be used. Ultimately, one of the advantages to embodiments of the invention is that the distance between the local host 50 and the peripheral 100 may be much greater than would be otherwise allowed by present USB distance constraints.

FIG. 3 is a functional block diagram that illustrates operation of a peripheral emulator 60 according to embodiments of the invention. As in FIG. 2, the peripheral emulator 60 is shown coupled between the local host 50 and the first communication transceiver 70.

Both the local host 50 and the peripheral emulator 60 include USB interfaces, or ports, respectively, and a USB cable 10 runs between the ports. Thus the local host 50 and the peripheral emulator 60 can communicate using USB. On the other hand, a serial cable 12 connects a serial port 64 of the peripheral emulator 60 to a serial port 74 of the first communication transceiver 70. As mentioned above, the serial cable 12 is just one possible way for the peripheral emulator 60 to communicate to the first communication transceiver 70. Alternative embodiments of the invention may use other conventional links, e.g., a parallel cable coupled to respective parallel ports, or other methods. Further the peripheral emulator 60 and communication transceiver 70 may be formed on a single chip or on a common printed circuit board, where the peripheral emulator 60 and communication transceiver 70 are connected by wire traces.

The peripheral emulator 60 may include a processor 66, a pair of data buffers 67, 69 and a loadable memory 68. During an initialization stage, the processor 66 receives the configuration information about the peripheral 100 that was gathered by the host emulator 90. The processor 66 can then load the received configuration information into the loadable memory 68. Thus, when the peripheral emulator 60 is enumerated by the local host 50, it can provide the USB configuration information that was previously obtained about the peripheral 100. In this way, the peripheral emulator 60 appears to the local host 50 to be the peripheral 100.

Thereafter, communication between the local host 50 and the peripheral emulator 60 commences as if the peripheral 100 were directly connected to the local host 50. Data buffers 67 and 69 of the peripheral emulator 60 can buffer the data received from the local host 50 and from the first communication transceiver 70 to counteract data latency in the received data stream, in either direction.

Depending on the type of communication link 76 (FIG. 2) that is coupled between the communication tranceivers 70, 80, the data buffers 67, 69 may not be necessary. For example, data transfer rates of present wireless transmission systems are not as fast as Hi-Speed USB, thus data may appear from the local host 50 faster than it can be transmitted by the transceiver 70 over the communication channel 76 (FIG. 2). In this case, the data buffers 67 or 69, or both, buffer the data in the peripheral emulator 60 until data may be sent to the local transceiver 70. On the other hand, if the communication link 76 is a high-speed device, such as high speed wireless or an optical fiber, the data arriving from the local host 50 may be sent to the first communication transceiver 70 immediately, without buffering the data. It is expected that as wireless technology matures, the data transfer rates that can be met by the system illustrated in FIG. 2 will match or exceed those presently available with wired USB. Embodiments of the invention will work equally well in either case.

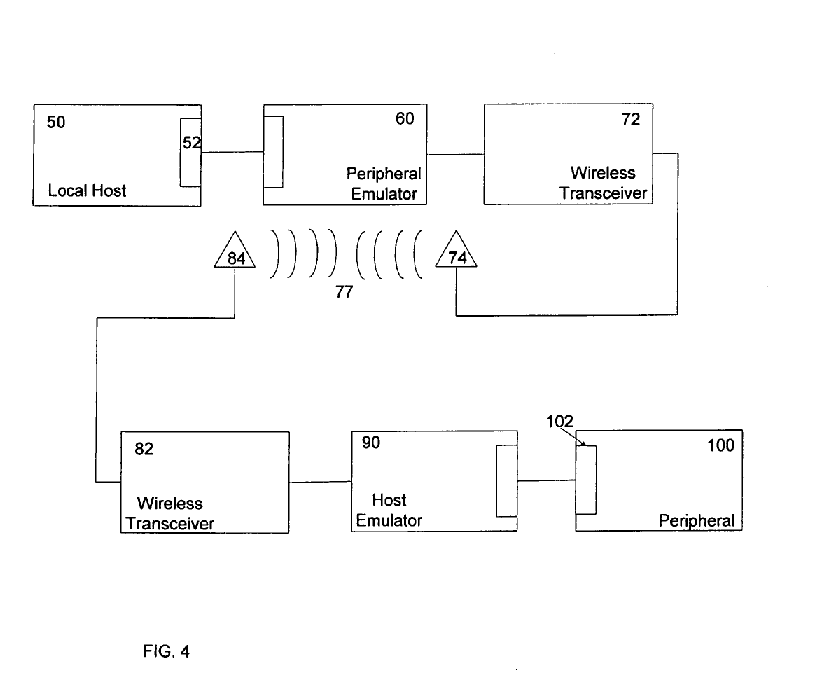

FIG. 4 is a block diagram that conceptually illustrates an apparatus and method for remote operation of a USB peripheral 100 by a local host 50 over a wireless communication channel 77, according to some embodiments of the invention. FIG. 4 is similar to FIG. 2, but in this case the first and second communication transceivers 70, 80 of FIG. 2 are represented by first and second radio transceivers 72, 82 and their associated antennas 74, 84. Also, the communication link 76 of FIG. 2 is now represented by a radio frequency (RF) link 77. The RF link may be at any appropriate frequency in the electromagnetic spectrum that comports to wireless regulations and meets appropriate standards. For instance, the wireless link 77 could be an infra-red (IR) link, or laser link.

In operation, the system illustrated in FIG. 4 operates similar to the one illustrated in FIG. 2. For instance, when the system is initially powered, the host emulator 90 enumerates/interrogates the peripheral 100. Once the endpoints and other configuration data is determined, the configuration data is sent from the transceiver 82 over the wirelesss link 77 to the transceiver 72. The transceiver 72 sends the data to the peripheral emulator 60, which configures itself to emulate the peripheral 100, as described above with reference to FIG. 3.

Once configured, in these embodiments of the invention, data is propagated between the local host 50 and the peripheral 100 by passing between the radio transceivers 72, 82. By appropriate modulation, the data can be extracted in either the radio transceivers 72, 82, or in their attached emulator components 60, 90. Thus, as shown in FIG. 4, the local host 50 and the peripheral 100 may be wirelessly “extended” beyond the limits defined in the USB specification.

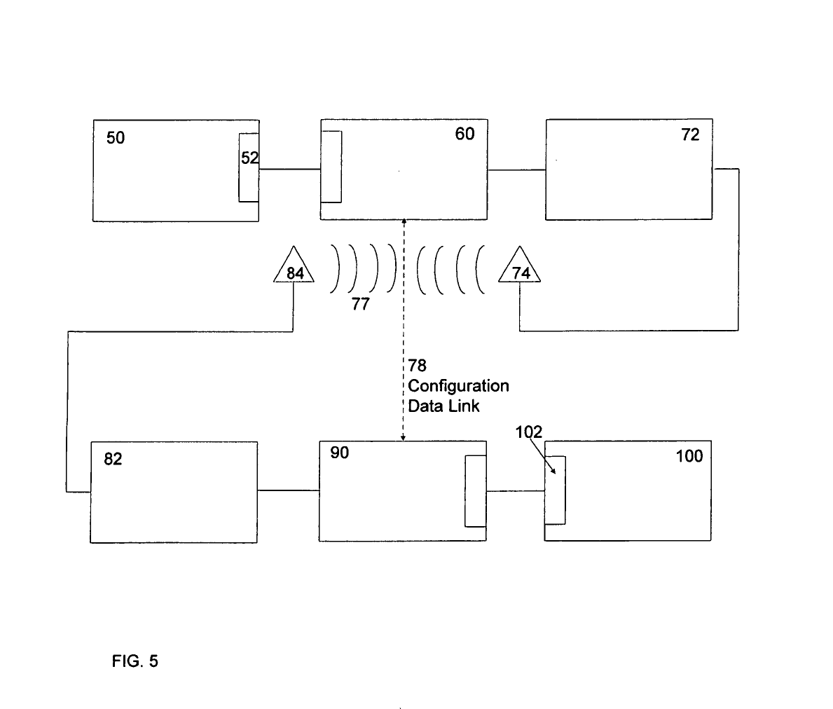

FIG. 5 is a block diagram that illustrates an alternate communication channel between the peripheral emulator 60 and the host emulator 90 according to other embodiments of the invention. FIG. 5 is similar to FIG. 4, but also includes the configuration data link 78 directly between the peripheral emulator 60 and the host emulator 90.

In these embodiments, after the host emulator enumerates/interrogates the peripheral 100, the configuration data is sent directly across the configuration data link 78, and not through the standard wireless link 77 between the transceivers 82, 72. Therefore, during this initial configuration, the first and second radio transceivers are bypassed. This embodiment may be useful for situations where the transceivers 72, 82 are set up to carry only data operational data between the local host 50 and the peripheral 100, and not set up to carry configuration data. In one particular embodiment, the emulators 60, 90 may be temporarily connected by a cable to make the data configuration link 78 during the configuration stage. Once the emulator 60 was configured, the data configuration link 78 could be severed, i.e., unplugged, and the emulators 60, 90 separated.

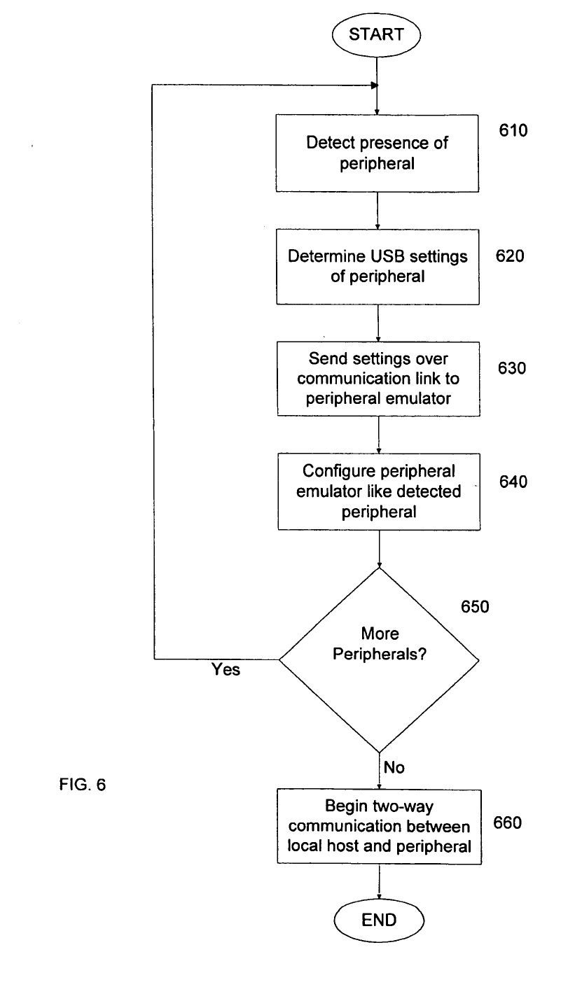

FIG. 6 is a flow diagram illustrating some of the processes performed by the embodiments of the invention shown in FIGS. 2-5. A flow 600 begins at a process 610, when the system is initialized. Initialization can occur when the system is initially powered, a peripheral turned on, a USB cable inserted into a port, or whenever a connect signal is given. After initialization, the process 610 seeks and detects the presence of any peripheral. In some embodiments of the invention there may be multiple peripherals. In other embodiments, a single peripheral may have multiple endpoints and seem like multiple separate peripherals. In any event, a process 620 determines the USB configuration settings of all of the peripherals, such as vendor id, device id, and product id. There may be a default configuration and alternate configurations as well, all of which can be detected by the emulated host 90.

After the USB configurations are known about the peripheral or peripherals, the configuration information is sent to the peripheral emulator, such as the emulator 60 of FIG. 3 in a process 630. As shown in FIG. 5, the configuration data may be sent over a special data configuration link 78, or, as shown in FIGS. 2 and 4, the configuration data may be sent over the ultimate communication channel, 76 or 77.

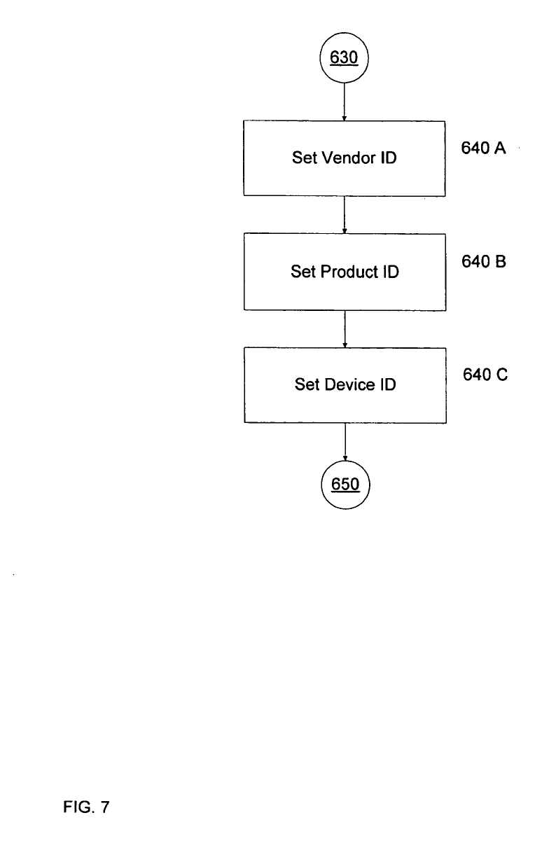

After the emulator 60 receives the configuration settings, it is set to emulate the detected peripheral device to the local host 50 in a process 640. Configuration of the emulator 60 may take place in conjunction with the local host 50, as is known in the art. In one embodiment, illustrated in FIG. 7, the emulator 60 is configured by setting a vendor id in a process 640a, a product id in a process 640b, and a device id in a process 640c.

Returning back to FIG. 6, a decision 650 determines if there are more peripheral devices attached to the host emulator 90. For instance, the peripheral 100, such as illustrated in FIG. 2 may actually be a USB hub that has multiple USB devices connected to it. In this case, the peripherals and the hub itself may each be interrogated/enumerated and data sent to the peripheral emulator 60. In some embodiments, each peripheral or peripheral setting may be set individually at the peripheral emulator 60. In other words, if there were three peripheral devices connected to the host emulator 90, the processes 610-640 would be repeated three times. After the peripheral emulator 60 is set to emulate the peripheral 100, two-way communication begins between the local host 50 and the peripheral 100 in a process 660 and as described above.

The approach outlined above is superior to conventional approaches because software compatibility with USB is maintained while the USB wire may be eliminated. The approach is scalable and may handle a variety of bandwidths, including Hi-Speed USB. The approach is also tolerant of hostile operating environments, and allows a variety of proprietary interfaces between the local host 50 and the peripheral 100.

One of ordinary skill in the art will recognize that the concepts taught herein can be tailored to a particular application in many other advantageous ways. In particular, those skilled in the art will recognize that the illustrated embodiments are but one of many alternative implementations that will become apparent upon reading this disclosure. For instance, a connection between a wide variety of local hosts and remote peripherals could be extended within the scope of the appended claims.

Many of the specific features shown herein are design choices. For example, the wireless RF link 77 illustrated in FIG. 5 is merely presented as an example. Likewise, functionality shown embodied in a single integrated circuit or functional block may be implemented using multiple cooperating circuits or blocks, or vice versa. Such minor modifications are encompassed within the embodiments of the invention, and are intended to fall within the scope of the claims.

The preceding embodiments are exemplary. Although the specification may refer to “an”, “one”, “another”, or “some” embodiment(s) in several locations, this does not necessarily mean that each such reference is to the same embodiment(s), or that the feature only applies to a single embodiment.

It will be appreciated by those skilled in the art that changes in these described embodiments of the invention may be made without departing from the principles and spirit of the invention itself, the scope of which is defined by the appended claims.

1. A method of operating a remote peripheral comprising:
interrogating the remote peripheral with a host emulator connected to the remote peripheral to determine configuration information associated with the remote peripheral;
transmitting the configuration information associated with the remote peripheral to a peripheral emulator connected to a local host;
configuring the peripheral emulator in the same manner as the remote peripheral; and
emulating the remote peripheral.

2. The method of claim 1, wherein the remote peripheral comprises a USB peripheral.

3. The method of claim 2, wherein configuration information comprises:
a number of USB endpoints, a direction for each of the USB endpoints, and a type for each of the USB endpoints.

4. The method of claim 3, wherein:
the number is in the range from 0 to 31, the direction is chosen from the group consisting of In and Out, and the type is chosen from the group consisting of control, interrupt, isochronous, and bulk.

5. The method of claim 1, wherein the local host is a personal computer.

6. The method of claim 2, wherein transmitting configuration information associated with the remote peripheral to the peripheral emulator comprises:
transmitting using a signal selected from the group consisting of a radio signal, a fiber-optic signal, a modem signal, and an infrared signal.

7. The method of claim 2, wherein emulating the remote peripheral comprises:
duplicating, between the host emulator and the remote peripheral, all USB traffic sent from the local host to the peripheral emulator; and
duplicating, between the peripheral emulator and the local host, all USB traffic sent from the remote peripheral to the host emulator.

8. A method comprising:
configuring a remote peripheral emulator coupled to a local host to emulate the attributes of a remote peripheral;
generating, using the remote peripheral emulator, the same traffic that the remote peripheral sends to a local host emulator that is coupled to the remote peripheral; and
generating, using the local host emulator, the same traffic that the local host sends to the remote peripheral emulator.

9. The method of claim 8, wherein the remote peripheral comprises a USB peripheral.

10. The method of claim 9, further comprising:
communicating between the local host and the remote peripheral using a signal selected from the group consisting of a radio signal, a fiber-optic signal, a modem signal, and an infrared signal.

11. The method of claim 9, wherein configuring the remote peripheral emulator coupled to the local host comprises:
transmitting the number, direction, and type of USB endpoints associated with the remote peripheral to the remote peripheral emulator.

12. The method of claim 9, further comprising:
allowing varying communication speeds and error rates while maintaining communication between the local host and the remote peripheral.

13. An apparatus comprising:
a local host coupled to a peripheral emulator, wherein the peripheral emulator is configured in the same manner as a remote peripheral that is coupled to a host emulator;
a local transceiver coupled to the peripheral emulator; and
a remote transceiver coupled to the host emulator.

14. The apparatus of claim 13, wherein the remote peripheral comprises a USB peripheral.

15. The apparatus of claim 13, wherein the local transceiver and the remote transceiver are configured to accept and transmit, respectively, a signal selected from the group consisting of a radio signal, a fiber-optic signal, a modem signal, and an infrared signal.

16. The apparatus of claim 13, wherein the local host is a personal computer.

17. A system comprising:
a local host;
a remote peripheral;
a host emulator coupled to the remote peripheral by a first USB link, the host emulator configured to enumerate the remote peripheral for configuration information;
a peripheral emulator coupled to the local host by a second USB link, the peripheral emulator configured to provide the local host with the configuration information;
a first and second communication transceiver coupled to the host emulator and the peripheral emulator, respectively; and
a first communication link between the first and the second communication transceivers.

18. The system of claim 17, wherein the first communication link comprises:
one chosen from the group consisting of a wireless RF link, a wireless IR link, an optical fiber link, a telephone link, and an Ethernet link.

19. The system of claim 17, wherein the system further comprises:
a second communication link between the peripheral emulator and the host emulator.

20. The system of claim 19, wherein the second communication link is configured to provide the configuration information to the peripheral emulator and the first communication link is configured to exchange USB signals between the local host and the remote peripheral.
